(19) United States
(12) Patent Application Publication
(10) Pub. No.: US 2015/0202634 A1
(43) Pub. Date: Jul. 23, 2015

(54) DISSOLVED GAS FLOTATION APPARATUS

(71) Applicant: DOOSAN ENPURE LIMITED, Birmingham (GB)

(72) Inventors: Tony Amato, Bridgnorth (GB); David Michael Brown, Stourbridge (GB)

(21) Appl. No.: 14/425,131

(22) PCT Filed: Sep. 3, 2013
(86) PCT No.: PCT/EP2013/068157

§ 371 Date: Mar. 2, 2015

(30) Foreign Application Priority Data
Sep. 4, 2012 (EP) 12183016.0

(51) Int. Cl. B03D 1/14; B01D 21/00; C02F 1/24

(52) U.S. Cl. CPC B03D 1/1431; C02F 1/24; B01D 21/0084; B03D 1/1412; C02F 2103/08

(57) ABSTRACT

A dissolved gas flotation apparatus (10) comprises: —a flotation tank (18) having an upstream contact zone by a baffle (9) from a downstream clarification zone; —one or more pressure reduction nozzles (28) arranged to discharge into the contact zone of the flotation tank (18); —a flow-straightening arrangement including two or more plate-like barriers (104) in the contact zone of the flotation tank (18), wherein: each barrier (104) has walls, the walls of the barriers (104) together defining flow paths in a desired direction; and each barrier (104) provides a barrier to horizontal flow perpendicular to the desired flow direction.

The present invention relates to a dissolved gas flotation apparatus and to methods of manufacture and use of the apparatus.

Dissolved gas flotation (also referred to as DAF, an abbreviation for “dissolved air flotation”) is a water treatment process. In DAF, water is clarified by the removal of suspended matter such as oil or solids. DAF is widely used in treating the industrial wastewater effluents from oil refineries, petrochemical and chemical plants, natural gas processing plants and similar industrial facilities. A very similar process known as induced gas flotation is also used for wastewater treatment. Froth flotation is commonly used in the processing of mineral ores.

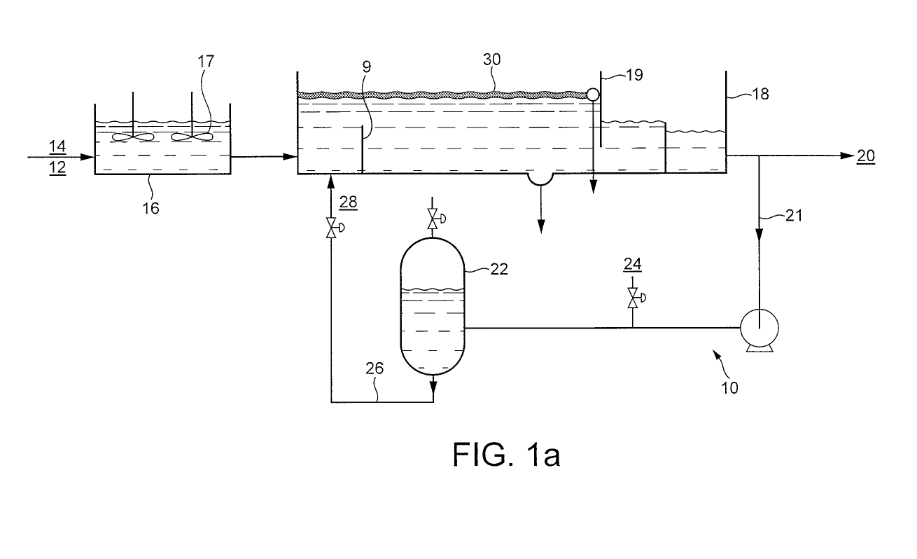

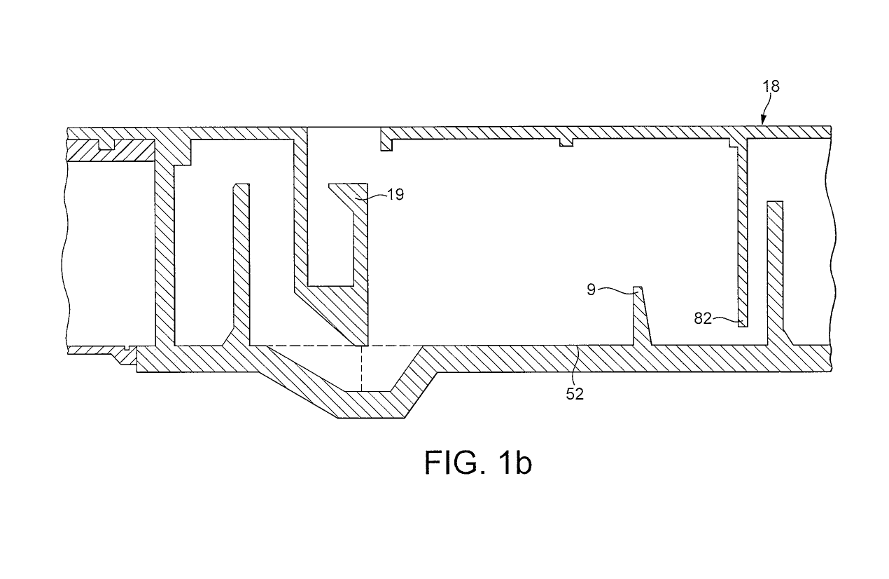

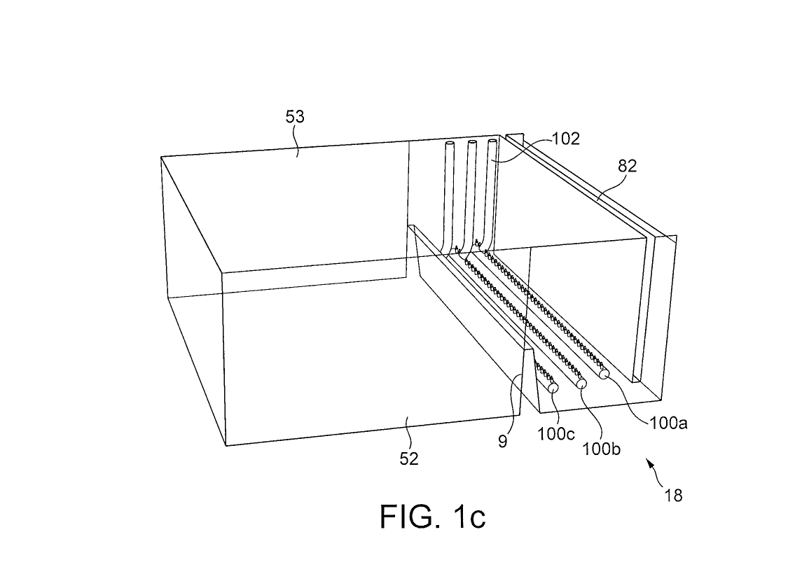

A typical DAF apparatus 10 is shown in FIG. 1a. Feed water 12 is introduced to the apparatus at the upstream end (left), where it may be dosed with a coagulant 14 (e.g. ferric chloride or aluminium sulfate) via an inline mixer or a flash mixer comprising a single mixer and small tank (not shown). The water is passed to a chemical mix flocculation tank 16 to flocculate the coagulated suspended matter. Impellers 17 are used for mixing in the flocculation tank 16. The water is then passed to a flotation tank (also referred to as a “cell”) 18 (of depth typically at least 3-5 m) at atmospheric pressure. The flotation tank 18 includes an underflow exit baffle 19 at the downstream end (right), allowing effluent water 20 to be withdrawn from the flotation tank 18. A portion of the effluent water 20 leaving the flotation tank 18 is recycled. The recycled water 21 is pumped into a saturator vessel (pressure vessel) 22 into which gas e.g. compressed air 24 is also introduced so that the water is saturated with gas. The gas-saturated water stream 26 is passed through pressure reduction nozzles 28 into the flotation tank 18. On passing through the pressure reduction nozzles 28, the gas is released from solution in the form of micro-bubbles which adhere to the suspended matter. The micro-bubbles rise to the surface of the water, carrying the suspended matter with them. The suspended matter forms a froth 30 which may then be removed using a skimming device. A suitable DAF pressure reduction nozzle 28 is described in WO2011/042494 of the current applicant. A suitable flotation tank is described in United Kingdom Patent Application No. 1208773.0 of the current applicant.

The flotation tank 18 is shown in more detail in FIGS. 1b and 1c (note that in these figures the upstream end is at the right and the downstream end at the left).

The flotation tank 18 has a base 52 and walls 53. An inlet underflow baffle 82 is provided at the upstream end. Close to the inlet and near the base 52 of the tank 18, three header pipes 100a, 100b, 100c (also generally referred to by 100) extend across the tank. The header pipes are supported by Y-shaped frames or angle irons (not shown). Each header pipe 100 is provided with pressure reduction nozzles spaced along its length. The header pipes 100 are fed via vertical pipes 102 along the wall of the tank.

An inclined baffle 9 is provided in the base 52 of the tank 18 downstream of the pressure reduction nozzles 28 in order to direct flow. Typically, the upstream wall of the baffle is inclined at least at its upper part in the downstream direction (from bottom to top). This baffle is referred to herein as the “inclined baffle” whether or not such an incline is present.

The part of the flotation tank 18 upstream of the inclined baffle 9, containing the pressure reduction nozzles 28, is referred to as the “contact zone”, as contact between micro-bubbles and suspended matter takes place here. The part of the flotation tank 18 downstream of the inclined baffle 9, where flotation occurs, is referred to as the “clarification zone”. There are no pressure reduction nozzles 28 in the clarification zone, and no air is introduced at this point.

Veolia Water Solutions and Technologies has developed a DAF apparatus and process referred to as SPIDFLOW™. This is described in IDAWC/PER11-219 and the SPIDFLOW™ brochure at http://www.veoliawateret.com/spidflow/en. The SPIDFLOW™ apparatus is used to protect sea water reverse osmosis plants from red tide bloom and oil spills. In the SPIDFLOW™ apparatus the DAF flotation tank is divided into a contact zone and a clarification zone by an overflow baffle (corresponding to the inclined baffle mentioned above). The clarification zone includes anti-spiral flow plates which are stated to break down any short circuits, and collection lines which distribute and collect water flow.

Flotation 2007 p. 147 relates to a water treatment plant for New York City. This document indicates that flow from the flocculation zone must be evenly introduced into the flotation zone for effective performance. It states that to achieve this, water should flow through a two-section flocculation/flotation transition zone and then enter the DAF recycle contact zone. The contact zone is separated from the clarification zone by a riser baffle wall (corresponding to the inclined baffle mentioned above).

U.S. Pat. No. 5,728,304 discloses a DAF apparatus wherein a mixture of untreated liquid and liquid saturated with dissolved air is passed through a series of upward deflecting screens placed across the flowpath in a rectangular tank. The screens are intended to prevent back-mixing and to bring the flow closer to vertically uniform laminar flow. Liquid containing dissolved air is also introduced downstream of each deflecting screen. No inclined baffle is present, and the tank is not divided into separate contact and clarification zones. Parallel flow channels are formed by vertical partitions extending substantially the full length of the tank.

The present inventors have appreciated that the impellers used for mixing in the flocculation tank can impart undesirable rotational momentum to water entering the flotation tank. This undesirable rotation momentum may affect the contact zone and the clarification zone, causing uneven flow.

In the contact zone, this may mean that contact between dissolved gas and solids is not uniform, so that bubble capture efficiency is reduced. It has been suggested that around 85% of the total DAF clarification process takes place in the contact zone, so that the chance of solid capture downstream is relatively low.

In the clarification zone, undesirable rotation momentum leading to uneven flow may mean that the sludge blanket is unevenly formed and cannot be uniformly removed when desludging hydraulically or mechanically.

As a result of these effects, there is a risk that particulates will leave the flotation tank in the effluent water, meaning that product water quality is poor.

In a first aspect, the present invention provides a dissolved gas flotation apparatus comprising:
a flotation tank having an upstream contact zone separated by a baffle from a downstream clarification zone;
one or more pressure reduction nozzles arranged to discharge into the contact zone of the flotation tank;
a flow-straightening arrangement including two or more plate-like barriers in the contact zone of the flotation tank, wherein: each barrier has walls, the walls of the barriers together defining flow paths in a desired direction; and each barrier provides a barrier to horizontal flow perpendicular to the desired flow direction.

The barriers desirably serve to reduce rotational momentum within a flow passing the flow-straightening arrangement. It is generally desirable to prevent flow across the flotation tank from one side to the other.

The barrier walls preferably define flow paths wherein movement of the treated stream in different directions parallel to the barrier walls is possible. In this way, the overall direction of the flow may be in the desired flow direction, but movement of the treated stream in other directions (e.g. vertical recirculation) is also possible within the flow.

The desired flow direction is preferably parallel to walls of the tank from an upstream end to a downstream end. This is also referred to as the forward direction. Generally, the barriers should present a small area to flow in the desired flow direction and a larger area to flow perpendicular to the desired flow direction, particularly in the horizontal plane. The term “plate-like” includes barriers which have a large area (provided by the walls which define flow paths) relative to their thickness. For example, the ratio of area to thickness may be at least 10 m, more preferably at least 25 m.

In alternative embodiments, a single barrier could be present and/or the barrier(s) could be non-plate-like.

Preferably, some or all of the barriers extend generally parallel to the desired flow direction. It is preferred for the barriers to extend parallel to one another and more preferred for the barriers to extend parallel to side walls of the flotation tank. The side walls of the flotation tank typically also co-operate with walls of the barriers to define flow paths in a desired direction.

Preferably, some or all of the walls of the barriers which define the flow paths are planar. More preferably, the walls are substantially parallel to walls of the flotation tank i.e. typically the walls are vertical.

Each barrier of the flow-straightening arrangement may also be provided with further parts in addition to the plate-like element e.g. a base plate, one or more plates used to join separate parts of the barrier, and/or other mounting arrangements.

Preferably, there are no members present which present a significant area to flow in the desired flow direction. Such members (e.g. vertical or inclined vanes extending across the tank) could present a barrier to flow in the desired direction and provide a coalescing surface promoting formation of undesirably large bubbles. Such bubbles may accelerate to the surface and disrupt the froth.

Preferably, the pressure reduction nozzles form part of a pressure reduction nozzle assembly, and more preferably they are provided on header pipes. Typically, 2 or 3 header pipes are present. The header pipes typically extend across the width of the tank, perpendicular to the desired flow direction.

Preferably, the barriers are located in the region of the header pipes. This means that the barriers overlap with the header pipes in the upstream-downstream direction (i.e. lie at least partially within a section of the tank having upstream and downstream limits defined by the upstream and downstream extremities of the header pipes). The barriers may lie entirely within this section of the tank, or may extend upstream and/or downstream of this section of the tank.

As an alternative, however, it is possible for the barriers to be provided upstream of the header pipes, and not in the region of the header pipes.

Preferably, the barriers support the pressure reduction nozzle assembly. More preferably, the barriers surround the header pipes.

In a preferred embodiment, the barriers are in the form of generally rectangular plates containing spaces through which the header pipes pass. Suitably, each barrier is provided in the form of two notched parts (e.g. upper and lower parts) which co-operate to form a plate containing such spaces.

Alternatively, the barriers could support the header pipes from underneath only.

Preferably, the barriers extend from the base of the flotation tank, but this is not essential.

Preferably, the barriers extend to a height 50% to 100% of the height of the baffle separating the contact zone from the clarification zone (referred to herein as the “inclined baffle” or the “overflow” or “riser” baffle as it typically extends from the base of the tank) e.g. typically in the range of 0.8 m to 1.5 m. The height of the inclined baffle is determined by the velocity of the water passing over it so as to ensure that maximum design velocities are not exceeded, and may for example be in the range of 1 m to 3 m. The baffle preferably extends across the tank in a direction perpendicular to the tank walls and desired flow direction.

Preferably, the height of the barriers is greater than the height of the space under the underflow inlet baffle.

Preferably, the barriers extend from the underflow inlet baffle at the upstream end of the contact zone to the inclined baffle. This helps to ensure that the barriers contact the bulk flow passing through the underflow inlet baffle. Again, however, this is not essential. The barriers may extend under the underflow inlet baffle.

Preferably, 3 to 7 barriers are provided. They are typically spaced across the width of the flotation tank.

Preferably, the barriers obstruct a maximum of 10%, more preferably a maximum of 5%, of the area defined by their outer limits (measured in a vertical plane across the tank). In this way, head loss (loss of pressure) and consequent loss of energy is minimised.

It is preferred that all components of the apparatus be acceptable for use with waters intended for potable supply. However, in practice DAF-treated water (e.g. sea water) may require further treatment (e.g. via a membrane process) to produce potable water. Where this is the case, it is not necessary for the components of the apparatus to be acceptable for use with waters intended for potable supply.

Preferably, the barriers are formed from the same material as the pressure reduction nozzle header pipes. This material may for example be plastics such as polypropylene, or may be stainless steel.

Preferably, all barriers of a flotation tank are identical, but this is not necessarily the case.

For small flotation tanks, preferably the header pipes may be lifted out of the tank. For large flotation tanks, the header pipes may be formed of two or more lengths.

Any or all of the components shown in FIGS. 1a to 1c and discussed above may also form part of the DAF apparatus. The pressure reduction nozzle of WO2011/042494 and the flotation tank of United Kingdom Patent Application No. 1208773.0, separately or in combination, are particularly preferred.

Preferred dimensions of the tank are as follows.

The tank length L (upstream to downstream) and width W are preferably in the ratio L:W of 1:1 to 2:1, but width may be greater than length. Suitably the tank width is in the range of 5 to 20 m. A suitable tank width where mechanical scrapers are used to remove sludge from the surface is about 10 m to 15 m. Where sludge is removed hydraulically tank widths of about 20 m are possible. Suitably, the tank depth is in the range of 3 to 6 m. Suitably, the height difference between the top wall of the inclined baffle and the lower wall of the underflow baffle is at least 0.75 m.

Preferably, the upstream wall of the inclined baffle is at an angle of 80 to 90° to the horizontal.

Preferably, there is a space of height 0.4 to 0.8 m under the underflow inlet baffle.

Preferably, the distance between the downstream wall of the underflow inlet baffle and the upstream wall of the inclined baffle is 2 to 3 m.

Suitably, the clarification zone is longer than the contact zone.

In a second aspect, the invention relates to a method of manufacturing a dissolved gas flotation apparatus as described above, comprising positioning the barriers within the contact zone of the flotation tank.

In a third aspect, the invention relates to a dissolved gas flotation process using the dissolved gas flotation apparatus described above, comprising:
supplying a feed stream to the flotation tank;
supplying a gas-saturated stream to the contact zone of the flotation tank via the pressure reduction nozzle(s); and
withdrawing an effluent stream from the clarification zone of the flotation tank.

Preferably, the dissolved gas is air. However, other gases may be used. For example, natural gas (essentially methane) may be used in the oil industry as the absence of oxygen helps to minimise explosion risk.

The flow per cell may for example be in the range of 1000 to 3000 m³/h. This is dependent on the desired retention time in the flocculation tank. Preferably, the retention time within the contact zone is 60 to 90 seconds.

Preferably, the temperature of the feed stream is up to 40° C.

The dissolved gas flotation process may be carried out on salt water or on non-saline water e.g. surface water.

In a fourth aspect, the invention relates to a salt water desalination process comprising an initial dissolved gas flotation process as described above. The process may include a distillation step, e.g a multi stage flash (MSF) step and/or may include a reverse osmosis step.

In further aspects, the invention relates to a barrier; a flow-straightening arrangement of barriers and optionally header pipes; a dissolved gas flotation apparatus, a method or a process substantially as herein described with reference to the description and/or drawings.

All features described in connection with any aspect of the invention can be used with any other aspect of the invention.

The invention will be further described with reference to preferred embodiments and to the drawings in which:

FIG. 1a is a schematic diagram of a known DAF apparatus.

FIG. 1b is a schematic diagram of the flotation tank of the apparatus of FIG. 1a.

FIG. 1c is a perspective view of an upstream part of the flotation tank of FIG. 1b.

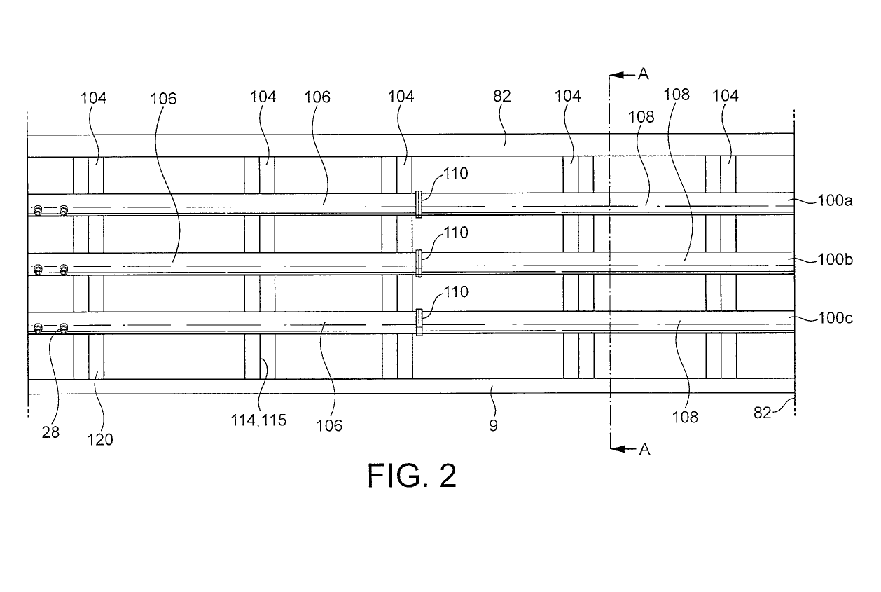

FIG. 2 is a plan view of the contact zone of a flotation tank of a preferred embodiment of the invention (only some pressure reduction nozzles are shown).

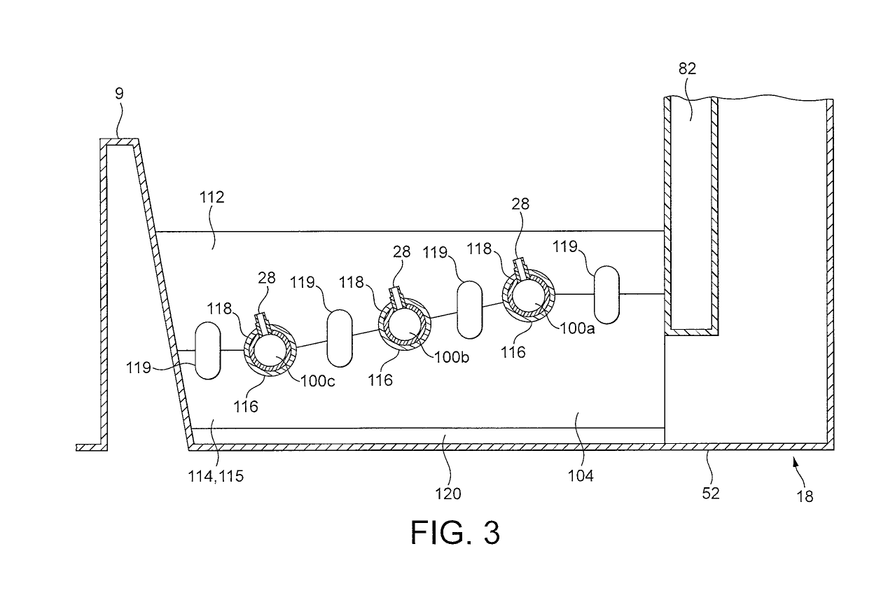

FIG. 3 is a cross-sectional view of the contact zone of FIG. 2 along line A-A.

The preferred embodiment of the invention is a flotation tank 18 similar to that described above in connection with FIGS. 1a to 1c, except for the inclusion of barriers 104 in the contact zone. These are shown in FIGS. 2 and 3.

Three circular cylindrical polypropylene header pipes 100a, 100b, 100c (in order from the inlet underflow baffle to the inclined baffle) are evenly spaced between the inlet underflow baffle 82 and the incline baffle 9. The header pipes 100 extend between side walls 53 across the width of the flotation tank 18, parallel to the base 52 of the flotation tank 18 and to the inlet underflow baffle 82, as generally described above.

Header pipe 100a is furthest from the base 52 of the flotation tank 18; header pipe 100b is intermediate in height and header pipe 100c is closest to the base of the tank.

Each header pipe 100 is provided in two lengths 106, 108. The lengths 106, 108 are bolted together via flanges 110 at their abutting ends. The outer ends (not shown) are capped and are positioned close to the side walls 53 of the flotation tank 18.

Each header pipe 100 is provided with 40-70 pressure reduction nozzles 28 spaced along its length which are directed to discharge in an upwards/downstream direction at an angle of approximately 20° below the vertical.

The header pipes 100 are surrounded and supported by 5 identical barriers 104 also formed of polypropylene. The barriers 104 extend in the upstream-downstream direction, parallel to the side walls of the flotation tank 18, from the underflow inlet baffle 82 to the inclined baffle 9. The barriers 104 are evenly spaced across the width of the flotation tank 18.

Each barrier 104 is formed of an upper part 112 and a lower part 114 which combine to provide a flow-straightening plate (thickness 30 mm) and a base support. The header pipes 100 lie between the upper parts 112 and lower parts 114 as described in more detail below.

The upper part 112 of each barrier 104 is in the form of a wedge-shaped plate element. The upper part has a vertical upstream edge which abuts the downstream wall of the underflow inlet baffle 82; a sloping downstream edge which abuts the upstream wall of the inclined baffle 9; a horizontal upper edge; and a lower edge which slopes generally downwards/downstream. The lower edge is provided with four small through holes (not shown) and three semi-circular notches 118 between the holes.

The lower part 114 of each barrier 104 includes a complementary wedge-shaped plate element 115. This element 115 has a vertical upstream edge aligned with the downstream wall of the underflow inlet baffle 82; a sloping downstream edge which abuts the upstream wall of the inclined baffle 9; a horizontal lower edge; and a sloping upper edge. The upper edge is provided with three semi-circular notches 116.

The wedge-shaped plate element 115 of the lower part 114 is provided with four aligned pairs of connection plates 119 extending from each face of its upper edge, offset from the plane of the wedge-shaped element 115 but parallel thereto. The connection plates 119 are extruder gun welded to the wedge-shaped element 115. Each connection plate 119 has a hole (not shown) at its distal end.

The lower part 114 also includes a rectangular base plate 120 at its lower end, extending in perpendicular fashion from the plate element 115 such that the lower part 114 has a generally T-shaped transverse cross-section.

Each upper part 112 is aligned with a respective lower part 114 to form a generally rectangular flow-straightening plate including three circular spaces each formed by co-operating semi-circular notches 116, 118. The header pipes 100a, 100b, 100c occupy these circular spaces. In this way, the barriers 104 support the header pipes 100 in position.

When the upper and lower parts 112, 114 are aligned, the upper part 112 sits between the pairs of connection plates 119 of the lower part 114. The holes (not shown) of the upper and lower parts 112, 114 are aligned and are used to bolt the parts together.

The faces (vertical side walls) of the flow-straightening plates of the barriers 104 and the side walls 53 of the flotation tank 18 together define flow paths from upstream to downstream. The barriers 104 together form a flow-straightening arrangement.

The barriers 104 have a height such that they extend above the lower wall of the underflow inlet 82 and are around 60% of the height of the incline baffle.

To assemble the flow-straightening arrangement, the lower parts 114 of the barriers 104 are bolted to the base 53 of the flotation tank 18 via base plates 120. The header pipes 100a, 100b, 100c are lowered into position. The upper parts 112 of the barriers 104 are then fitted to the lower parts 114 as described above.

The DAF apparatus including the flotation tank is operated as explained above. In use, as water enters the contact zone of the flotation tank 18 via the inlet underflow baffle 82, the bulk of the flow passes along the desired flow paths between the barriers 104 or between the barriers 104 and the side walls 53 of the flotation tank 18 (and around the header pipes 100a, 100b, 100c). Contact with the flow-straightening plates reduces rotational momentum in the flow.

The inventors have simulated the effect of barriers on the flotation tank of a water treatment plant at Hornsey. Where no barriers were used, flow tended towards one side of the tank. Where barriers were included (upstream of the pressure reduction nozzles in this case), the flow was more even.

The preferred embodiments of the invention are believed to have following advantages:
The barriers address the problem of undesired horizontal rotational momentum in the flotation tank discussed above. When water enters the flotation tank via the inlet underflow baffle, the flow passes between the barrier plates. Momentum perpendicular to the plates is inhibited by impact with the plates, helping to ensure an even flow of flocculated material across the width of the tank. Momentum parallel to the plates is not affected. Thus, the flow tends to be directed parallel to the plates in the downstream direction.
The barrier plates support the header pipes for the pressure reduction nozzles. This means that the use of alternative supports such as Y-shaped frames or angle irons is not necessary.
The barrier plates present a small area in the desired flow direction, so that head loss and consequent loss of energy are small.
Vertical rotational momentum within the flow paths is not inhibited by the barrier plates in the contact or clarification zones. Such vertical rotational momentum (referred to as “back flow” or “back mixing”) helps to ensure that bubble-floc agglomerates are retained in the tank for longer than hydraulic retention calculations would suggestion, improving the quality of the product stream.
The barrier plates are vertical and do not present a significant horizontal or inclined surface on which solids can accumulate or bubbles can coalesce.

Thus, the preferred embodiment of the invention provides a simple and cost-effective arrangement in which the problem of undesired rotational momentum is addressed. It avoids the need for one or more transition tanks between the flocculation tank and the flotation tank (as proposed in Flotation 2007), and the associated costs.

Although the invention has been described with reference to the illustrated preferred embodiments, it will be recognised that various modifications are possible within the scope of the invention.

### REFERENCES

IDAWC/PER11-219—International Desalination Association World Congress/Perth Covention and Exhibition Centre (PCEC), Perth, Western Australia September 4-9 2011
Flotation 2007 (5^{th} International Conference on Flotation in Water and Wastewater Systems), September 11-14, Seoul, Republic of Korea, p. 147 “Going Underground—Constructing New York City's first Water Treatment Plant, a 1,100 ML/d Dissolved Air Flotation, Filtration and UK Facility”, I. A. Crossley et al., from Hazen & Sawyer

1. A dissolved gas flotation apparatus comprising:
a flotation tank having an upstream contact zone separated by a baffle from a downstream clarification zone;
one or more pressure reduction nozzles arranged to discharge into the contact zone of the flotation tank;
a flow-straightening arrangement including two or more plate-like barriers in the contact zone of the flotation tank, wherein: each barrier has walls, the walls of the barriers together defining flow paths; and each barrier provides a barrier to horizontal flow perpendicular to the flow paths.

2. A dissolved gas flotation apparatus as claimed in claim 1, wherein the barriers extend parallel to the flow paths.

3. A dissolved gas flotation apparatus as claimed in claim 1, wherein some or all of the walls of the barriers defining the flow paths are planar and are substantially vertical.

4. A dissolved gas flotation apparatus as claimed in claim 1, wherein the pressure reduction nozzles form part of a pressure reduction nozzle assembly and the barriers support the pressure reduction nozzle assembly.

5. A dissolved gas flotation apparatus as claimed in claim 4, wherein the barriers support header pipes of the pressure reduction nozzle assembly.

6. A dissolved gas flotation apparatus as claimed in claim 5, wherein the barriers surround the header pipes.

7. A dissolved gas flotation apparatus as claimed in claim 1, wherein the barriers extend from the base of the flotation tank.

8. A dissolved gas flotation apparatus as claimed in claim 1, wherein the barriers extend to a height 50% to 100% of the height of the baffle separating the contact zone from the clarification zone.

9. A dissolved gas flotation apparatus as claimed in claim 1, wherein the barriers extend from an upstream end of the contact zone to the baffle separating the contact zone from the clarification zone.

10. A dissolved gas flotation apparatus as claimed in claim 1, wherein 3 to 7 barriers are provided.

11. A method of manufacturing a dissolved gas flotation apparatus as claimed in claim 1, comprising positioning the barriers within the contact zone of the flotation tank.

12. A dissolved gas flotation process using the dissolved gas flotation apparatus of claim 1, comprising:
supplying a feed stream to the flotation tank;
supplying a gas-saturated stream to the contact zone of the flotation tank via the pressure reduction nozzle; and
withdrawing an effluent stream from the clarification zone of the flotation tank.

13. A salt water desalination process comprising an initial dissolved gas flotation process as claimed in claim 12.
